(19) United States
(12) Patent Application Publication
(10) Pub. No.: US 2013/0235002 A1
(43) Pub. Date: Sep. 12, 2013

(54) AUTO STEREOSCOPIC DISPLAY APPARATUS

(71) Applicants: Chih-Yin Chiang, Nantou County (TW); Tso-Hsuan Yeh, Taoyuan County (TW); Che-Wei Chang, Taoyuan County (TW)

(72) Inventors: Chih-Yin Chiang, Nantou County (TW); Tso-Hsuan Yeh, Taoyuan County (TW); Che-Wei Chang, Taoyuan County (TW)

(73) Assignee: CHUNGHWA PICTURE TUBES, LTD., Taoyuan (TW)

(21) Appl. No.: 13/553,769

(22) Filed: Jul. 19, 2012

(30) Foreign Application Priority Data
Mar. 8, 2012 (TW) 101107885

(51) Int. Cl. G09G 5/00

(52) U.S. Cl. 345/204

(57) ABSTRACT

An auto-stereoscopic display apparatus includes a liquid crystal lens array and a display panel. The liquid crystal lens array includes a first substrate, a second substrate, and a liquid crystal layer. The first substrate has a plurality of first driving electrodes and a plurality of second driving electrodes. The second substrate is located opposite to the first substrate and has a common electrode. The liquid crystal layer is located between the first substrate and the common electrode of the second substrate. The display panel has a plurality of pixels arranged in array. These pixels are divided into first and second pixels. When the first driving electrodes are enabled, the first pixels display a first left-eye sub-frame, and the second pixels display a first right-eye sub-frame. When the second driving electrodes are enabled, the first pixels display a second right-eye sub-frame, and the second pixels display a second left-eye sub-frame.

### CROSS-REFERENCE TO RELATED APPLICATION

This application claims the priority benefit of Taiwan application serial no. 101107885, filed on Mar. 8, 2012. The entirety of the above-mentioned patent application is hereby incorporated by reference herein and made a part of this specification.

### BACKGROUND OF THE INVENTION

1. Field of the Invention

The invention relates to a stereoscopic display apparatus. More particularly, the invention relates to an auto-stereoscopic display apparatus.

2. Description of Related Art

Auto-stereoscopic display technologies that are widely developed at present are mainly categorized into two types: the spatial multiplexing stereoscopic display technology and the temporal multiplexing stereoscopic display technology. These two types of displays are operated on condition that the human brain can fuse different images respectively perceived by left and right eyes, so as to generate a stereoscopic image vision.

According to the conventional temporal multiplexing display technology, a stereoscopic image display projects an image at one viewing angle into the left eye of a viewer at a time point and projects an image at another viewing angle into the right eye of the viewer at the next time point. If the images at the two viewing angles are switched fast enough, the brain will be unaware of the image switch, so as to fuse the images at the two viewing angles and generate a stereoscopic image pair. By contrast, according to the spatial multiplexing display technology, in order to accomplish the stereoscopic image effect, a lenticular lens or a parallax barrier is often applied to form different viewing zones within the space, such that a user is allowed to receive different image information respectively with the left and right eyes. Nonetheless, the spatial multiplexing display technology leads to the reduction of resolution of the stereoscopic display image.

### SUMMARY OF THE INVENTION

The invention is directed to an auto-stereoscopic display apparatus capable of displaying an image at full resolution.

In an embodiment of the invention, an auto-stereoscopic display apparatus is provided. The auto-stereoscopic display apparatus includes a liquid crystal lens array and a display panel. The display panel has a plurality of pixels arranged in array. These pixels are divided into a plurality of first pixels and a plurality of second pixels. When the first driving electrodes are enabled, and the second driving electrodes are disabled, the first pixels display a first left-eye sub-frame, and the second pixels display a first right-eye sub-frame. When the second driving electrodes are enabled, and the first driving electrodes are disabled, the first pixels display a second right-eye sub-frame, and the second pixels display a second left-eye sub-frame. The liquid crystal lens array includes a first substrate, a second substrate, and a liquid crystal layer. The first substrate has a plurality of first driving electrodes electrically connected to one another and a plurality of second driving electrodes electrically connected to one another. The first driving electrodes are electrically insulated from the second driving electrodes. The first driving electrodes and the second driving electrodes are alternately arranged. The second substrate is located opposite to the first substrate and has a common electrode. The liquid crystal layer is located between the first substrate and the common electrode of the second substrate.

According to an embodiment of the invention, within a first sub-frame period, the first pixels display the first left-eye sub-frame, and the second pixels display the first right-eye sub-frame. Within a second sub-frame period, the first pixels display the second right-eye sub-frame, and the second pixels display the second left-eye sub-frame. The first sub-frame period, the second sub-frame period, and a time interval between the first sub-frame period and the second sub-frame period in total are shorter than or equal to a visual persistence time frame of human eyes.

According to an embodiment of the invention, the first driving electrodes and the common electrode together form a first electric field distribution, and the second driving electrodes and the common electrode together form a second electric field distribution. The first electric field distribution and the second electric field distribution do not overlap.

According to an embodiment of the invention, the first substrate further includes an insulating layer located between the first driving electrodes and the second driving electrodes.

According to an embodiment of the invention, the second driving electrodes are located on the same plane where the insulating layer is located, and the second driving electrodes are also located between the insulating layer and the second substrate. Besides, the first substrate further has a first base. The first driving electrodes and the second driving electrodes are located on the first base. The first driving electrodes are located on the same plane of the first base, and the first driving electrodes are also located between the insulating layer and the first base.

According to an embodiment of the invention, the first driving electrodes and the second driving electrodes are located on a same plane.

According to an embodiment of the invention, an extension direction of the first driving electrodes is parallel to an extension direction of the second driving electrodes. The pixels are arranged in matrix along a column direction and a row direction, and the extension direction of the first driving electrodes and the extension direction of the second driving electrodes interlace with the column direction and the row direction.

According to an embodiment of the invention, the first pixels and the second pixels are alternately arranged in the column direction and the row direction.

According to an embodiment of the invention, an extension direction of the first driving electrodes is parallel to an extension direction of the second driving electrodes. The pixels are arranged in matrix along a column direction and a row direction. The extension direction of the first driving electrodes and the extension direction of the second driving electrodes are substantially parallel to the column direction.

According to an embodiment of the invention, the first pixels are arranged in a plurality of first columns along the column direction. The second pixels are arranged in a plurality of second columns along the column direction. The first columns and the second columns are alternately arranged along the row direction.

Based on the above, the auto-stereoscopic display apparatus described in the embodiments of the invention drives two alternately-arranged sets of driving electrodes within different sub-frame periods, such that the liquid crystal lens array may guide a plurality of sub-frames displayed by two sets of pixels to the left and right eyes of a user. The user is thus allowed to watch a stereoscopic image at full resolution on the display apparatus.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1A and FIG. 1B respectively illustrate a status of an auto-stereoscopic display apparatus within a first sub-frame period and a second sub-frame period according to an embodiment of the invention.

FIG. 1C is a schematic view illustrating a liquid crystal lens array according to an embodiment of the invention.

FIG. 1D illustrates a driving state of the liquid crystal lens array depicted in FIG. 1A and FIG. 1B within a certain time period and images perceived by left and right eyes of a user.

FIG. 2A and FIG. 2B respectively illustrate a configuration of pixels of a display panel within a first sub-frame period and a second sub-frame period according to an embodiment of the invention.

FIG. 3A illustrates a correlation between first driving electrodes and pixels of a display panel.

FIG. 3B illustrates a correlation between second driving electrodes and pixels of a display panel.

FIG. 4A illustrates another correlation between first driving electrodes and pixels of a display panel.

FIG. 4B illustrates another correlation between second driving electrodes and pixels of a display panel.

### DESCRIPTION OF EMBODIMENTS

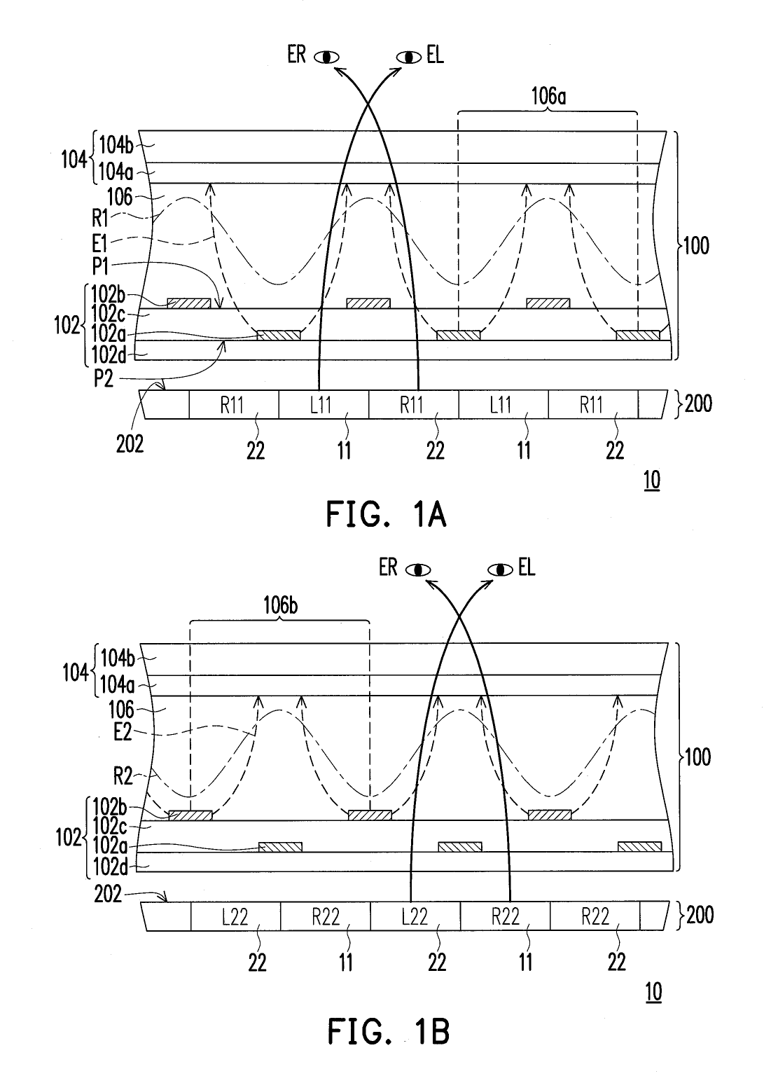

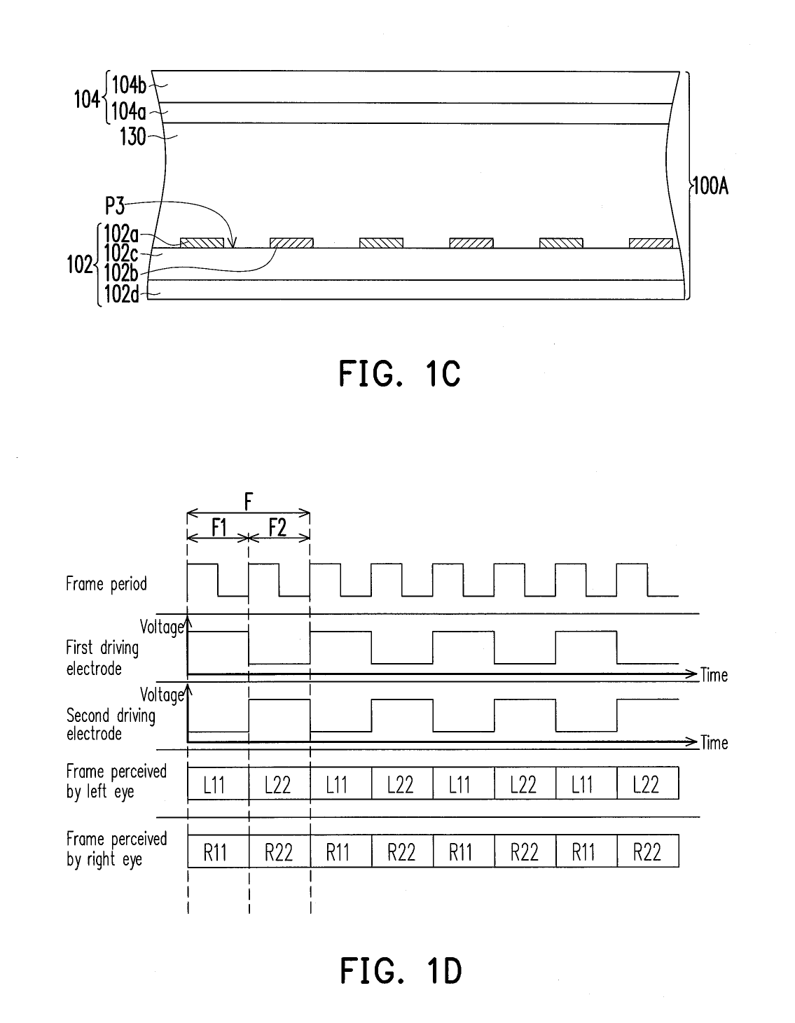

FIG. 1A and FIG. 1B respectively illustrate a status of an auto-stereoscopic display apparatus within a first sub-frame period and a second sub-frame period according to an embodiment of the invention. With reference to FIG. 1A and FIG. 1B, an auto-stereoscopic display apparatus 10 includes a liquid crystal lens array 100 and a display panel 200. In the present embodiment, the display panel 200 may be a liquid crystal panel, for instance. However, the invention is not limited thereto, and the display panel 200 described in other embodiments may be an organic light-emitting display panel, a plasma display panel, an electrophoretic display panel, an electro-wetting display panel, or any other appropriate display panel.

The display panel 200 described in the present embodiment has a plurality of pixels arranged in array. These pixels may be divided into a plurality of first pixels 11 and a plurality of second pixels 22. Besides, the display surface 202 of the display panel 200 faces toward the liquid crystal lens 100. Consequently, the liquid crystal lens array 100 may pose an impact on images displayed on the display panel 200, so as to generate a stereoscopic display vision.

The liquid crystal lens array 100 described in the present embodiment includes a first substrate 102, a second substrate 104, and a liquid crystal layer 106. The first substrate 102 has a plurality of first driving electrodes 102a electrically connected to one another and a plurality of second driving electrodes 102b electrically connected to one another. The first driving electrodes 102a are electrically insulated from the second driving electrodes 102b. Besides, the first driving electrodes 102a and the second driving electrodes 102b are alternately arranged.

According to the present embodiment, the first driving electrodes 102a and the second driving electrodes 102b may belong to different film layer. That is to say, the first driving electrodes 102a and the second driving electrodes 102b may be located on different planes. In particular, the first substrate 102 may further include an insulating layer 102c located between the first driving electrodes 102a and the second driving electrodes 102b. The second driving electrodes 102b are located on the same plane P1 where the insulating layer 102c is located, and the second driving electrodes 102b are also located between the insulating layer 102c and the second substrate 104. The first substrate 102 further having a first base 102d. The first driving electrodes 102a and the second driving electrodes 102b are located on the first base 102d. Besides, the first driving electrodes 102a are located on the same plane P2 where the first base 102d is located, and the first driving electrodes 102a are also located between the insulating layer 102c and the first base 102d.

However, the configuration of the first substrate is not limited to the above. According to another embodiment of the invention, the first driving electrodes and the second driving electrodes of the first substrate may be properly designed to be located on the same plane. This will be explained below with reference to the drawings. FIG. 1C is a schematic cross-sectional view illustrating a liquid crystal lens array according to another embodiment of the invention. With reference to FIG. 1C, in the present embodiment, the first driving electrodes 102a and the second driving electrodes 102b of the liquid crystal lens array 100A may be located on the same plane. To be more specific, the first driving electrodes 102a and the second driving electrodes 102b are located on the same plane P3 where the insulating layer 102c is located, and the first driving electrodes 102a and the second driving electrodes 102b are also located between the insulating layer 102c and the second substrate 104.

As shown in FIG. 1A, the second substrate 104 described in the present embodiment is located opposite to the first substrate 102 and has a common electrode 104a. The liquid crystal layer 106 is located between the first substrate 102 and the common electrode 104a of the second substrate 104. In the present embodiment, the second substrate 104 may further has a second base 104b. The first and second bases 102d and 104b may be rigid bases and may be made of glass, for instance. However, the invention is not limited thereto, and the first and second bases 102d and 104b described in another embodiment of the invention may be flexible bases and may be made of plastic, for instance.

In the liquid crystal lens array 100 described in the present embodiment, the liquid crystal layer 106 as a whole may be in a homogenic state when the first driving electrodes 102a, the second driving electrodes 102b, and the common electrode 104a are not driven. When the first driving electrodes 102a and the common electrode 104a are driven, and the second driving electrodes 102b are not driven (i.e., there is a voltage difference between the first driving electrodes 102a and the common electrode 104a, and there is no voltage difference between the second driving electrodes 102b and the common electrode 104a), the first driving electrodes 102a and the common electrode 104a together produce a first electric field distribution E1. When the second driving electrodes 102b and the common electrode 104a are driven, and the first driving electrodes 102a are not driven (i.e., there is a voltage difference between the second driving electrodes 102b and the common electrode 104a, and there is no voltage difference between the first driving electrodes 102a and the common electrode 104a), the second driving electrodes 102b and the common electrode 104a together produce a second electric field distribution E2. The first electric field distribution El and the second electric field distribution E2 do not overlap. Here, the first electric field distribution El and the second electric field distribution E2 may change the arrangement of liquid crystal molecules in the liquid crystal layer 106, such that the liquid crystal layer 106 exhibits a certain refractive index distribution. At this time, the refractive index distribution of the liquid crystal layer 106 achieves effects similar to those accomplished by an optical lens array. Since the liquid crystal lens array 100 poses an impact on images composed of the first pixels 11 and the second pixels 22 of the display panel 200, the images may be traveled toward different directions (i.e., different viewing zones are formed), so as to achieve a stereoscopic image vision.

FIG. 1D illustrates a driving state of the liquid crystal lens array depicted in FIG. 1A and FIG. 1B within a certain time period and images perceived by left and right eyes of a user. With reference to FIG. 1D, the time period required by the auto-stereoscopic display apparatus for displaying a complete stereoscopic image is a frame period F according to the present embodiment. Each frame period F includes a first sub-frame period F1 and a second sub-frame period F2. FIG. 1A and FIG. 1B respectively illustrate the condition of the liquid crystal lens array within the first sub-frame period F1 and the second sub-frame period F2.

As shown in FIG. 1A, FIG. 1B, and FIG. 1D, in the stereoscopic display mode, a method of driving the liquid crystal lens array 100 includes driving the first driving electrodes 102a and the second driving electrodes 102b respectively within the first sub-frame period F1 and the second sub-frame period F2. With reference to FIG. 1A and FIG. 1C, within the first sub-frame period F1, the first driving electrodes 102a are enabled, and the second driving electrodes 102b are disabled. At this time, the refractive index distribution of the liquid crystal layer 106 may be represented by a curve R1 due to the impact of the first electric field distribution E1, such that a plurality of first lens units 106a are formed in the liquid crystal layer 106. Here, the functions of the first lens units 106a are similar to those of an optical lens. The refractive index of each of the first lens units 106a gradually decreases from the central area (between two adjacent first driving electrodes 102a) to the two side areas, as represented by the curve R1. Here, the first lens units 106a are capable of gathering and focusing light beams.

With reference to FIG. 1A and FIG. 1D, within the first sub-frame period F1, a first left-eye sub-frame L11 composed of the first pixels 11 is refracted by the first lens units 106a and traveled to leave the auto-stereoscopic display apparatus 10 toward the upper-right corner of FIG. 1A, and the first left-eye sub-frame L11 is then transmitted to the left eye EL of a user. Besides, a first right-eye sub-frame R11 composed of the second pixels 22 is refracted by the first lens units 106a and traveled to leave the auto-stereoscopic display apparatus 10 toward the upper-left corner of FIG. 1A, and the first right-eye sub-frame R11 is then transmitted to the right eye ER of the user. The user can simultaneously receive the first left-eye sub-frame L11 and the first right-eye sub-frame R11 within the first sub-frame period F1. The brain of the user is capable of fusing the first left-eye sub-frame L11 and the first right-eye sub-frame R11, so as to allow the user to watch the first stereoscopic frame.

Nonetheless, in the present embodiment, the liquid crystal lens array 100 serves to transmit the sub-frames composed of adjacent first and second pixels 11 and 22 toward different directions. In other words, within the first sub-frame period F1, the auto-stereoscopic display apparatus 10 displays the stereoscopic image in a spatial multiplexing manner. At this time, the image information captured or received by either the left eye or the right eye of the user is half the total number of the pixels of the display panel 200. Namely, within the first sub-frame period F1, an resolution of an image displayed by the auto-stereoscopic display apparatus 10 is half of an resolution of an image displayed by the display panel 200.

To allow the user to observe the stereoscopic frame at full resolution with the second sub-frame period F2, the auto-stereoscopic display apparatus 10 described in the present embodiment can display a second left-eye sub-frame L22 and a second right-eye sub-frame R22 respectively complementary to the first left-eye sub-frame L11 and the first right-eye sub-frame R11.

In particular, as shown in FIG. 1B and FIG. 1C, within the subsequent second sub-frame period F2, the second driving electrodes 102b are enabled, and the first driving electrodes 102a are disabled. At this time, the refractive index distribution of the liquid crystal layer 106 may be represented by a curve R2 due to the impact of the second electric field distribution E2, such that a plurality of second lens units 106b are formed in the liquid crystal layer 106. Here, the functions of the second lens units 106b are similar to those of an optical lens. It can be learned from FIG. 1A and FIG. 1B that the spatial distribution of the first lens units 106a and the second lens units 106b does not overlap. Namely, there is a relative displacement between the first and second lens units 106a and 106b. As indicated in FIG. 1B, within the second sub-frame period F2, the second right-eye sub-frame R22 composed of the first pixels 11 is refracted by the second lens units 106b and traveled to leave the auto-stereoscopic display apparatus 10 toward the upper-left corner of FIG. 1B, and the second right-eye sub-frame R22 is then transmitted to the right eye ER of the user. Besides, the second left-eye sub-frame L22 composed of the second pixels 22 is refracted by the second lens units 106b and traveled to leave the auto-stereoscopic display apparatus 10 toward the upper-right corner of FIG. 1B, and the second left-eye sub-frame L22 is then transmitted to the left eye EL of the user. The user can simultaneously receive the second left-eye sub-frame L22 and the second right-eye sub-frame R22 within the second sub-frame period F2. The brain of the user is capable of fusing the second left-eye sub-frame L22 and the second right-eye sub-frame R22, so as to allow the user to watch the second stereoscopic frame.

It should be mentioned that the first sub-frame period F1, the second sub-frame period F2, and a time interval (0 in FIG. 1C) between the first sub-frame period F1 and the second sub-frame period F2 in total are shorter than or equal to a visual persistence time frame (e.g., 62.5 ms to 200 ms) of human eyes. Thereby, the user's brain is able to combine the first stereoscopic image (constituted by the first left-eye sub-frame L11 and the first right-eye sub-frame R11) at half the resolution and the second stereoscopic image (constituted by the second left-eye sub-frame L22 and the second right-eye sub-frame R22) at the other half the resolution, so as to generate the stereoscopic image at full resolution, and the stereoscopic image is visible to the user. In other words, the auto-stereoscopic display apparatus 10 in a stereoscopic display mode allows the user to observe the stereoscopic image at full resolution through the combination of spatial and temporal multiplexing technologies.

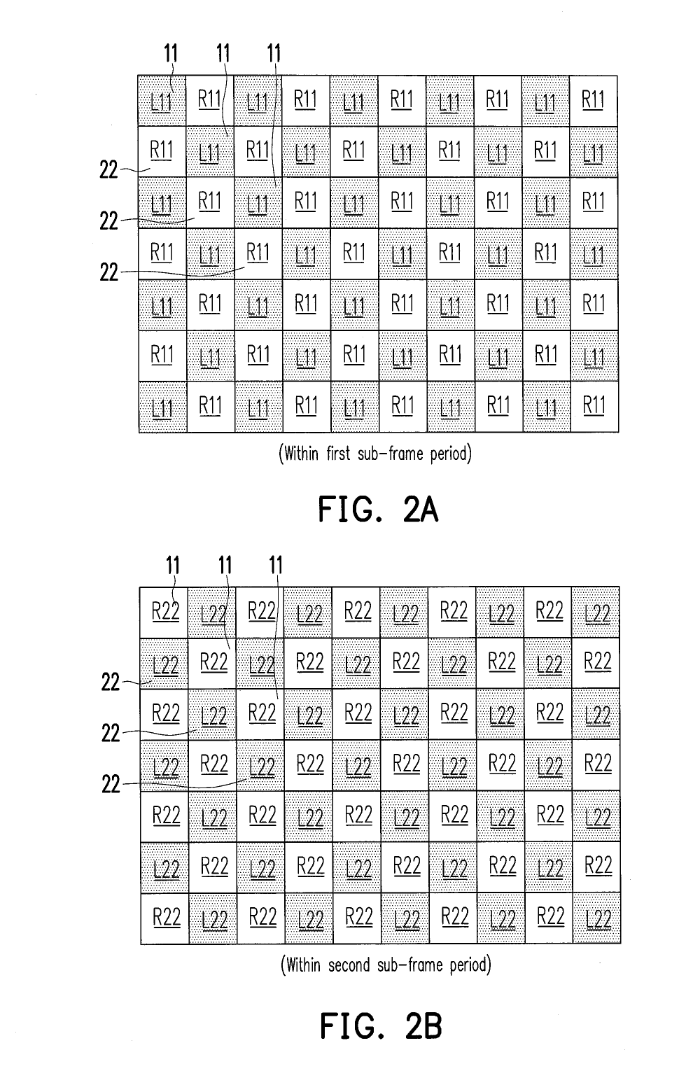

The stereoscopic display mechanism of the auto-stereoscopic display apparatus 10 is further described in the present embodiment with reference to FIG. 2A and FIG. 2B. FIG. 2A and FIG. 2B respectively illustrate a display state of pixels of a display panel within a first sub-frame period and a second sub-frame period. As shown in FIG. 2A, within the first sub-frame period F1, the right eye of the user can receive one portion of the frame at the right-eye viewing angle, and the frame (i.e., the first right-eye sub-frame R11) is composed of the second pixels 22. In FIG. 2B, within the second sub-frame period F2, the right eye of the user can receive the other portion of the frame at the right-eye viewing angle, and the frame (i.e., the second right-eye sub-frame R22) is composed of the first pixels 11.

Similarly, as shown in FIG. 2A, within the first sub-frame period F1, the left eye of the user can receive a portion of the frame at the left-eye viewing angle, and the frame (i.e., the first left-eye sub-frame L11) is composed of the first pixels 11. In FIG. 2B, within the second sub-frame period F2, the left eye of the user can receive the other portion of the frame at the left-eye viewing angle, and the frame (i.e., the second left-eye sub-frame L22) is composed of the second pixels 22. Thereby, as the complete frame period goes by, the frames displayed within the two sub-frame periods are combined to generate a complete frame at the right-eye and left-eye viewing angles. As such, the image resolution sensed by the user is equal to the numbers of all the pixels of the display panel 200, and the user is thus allowed to observe the stereoscopic image at full resolution.

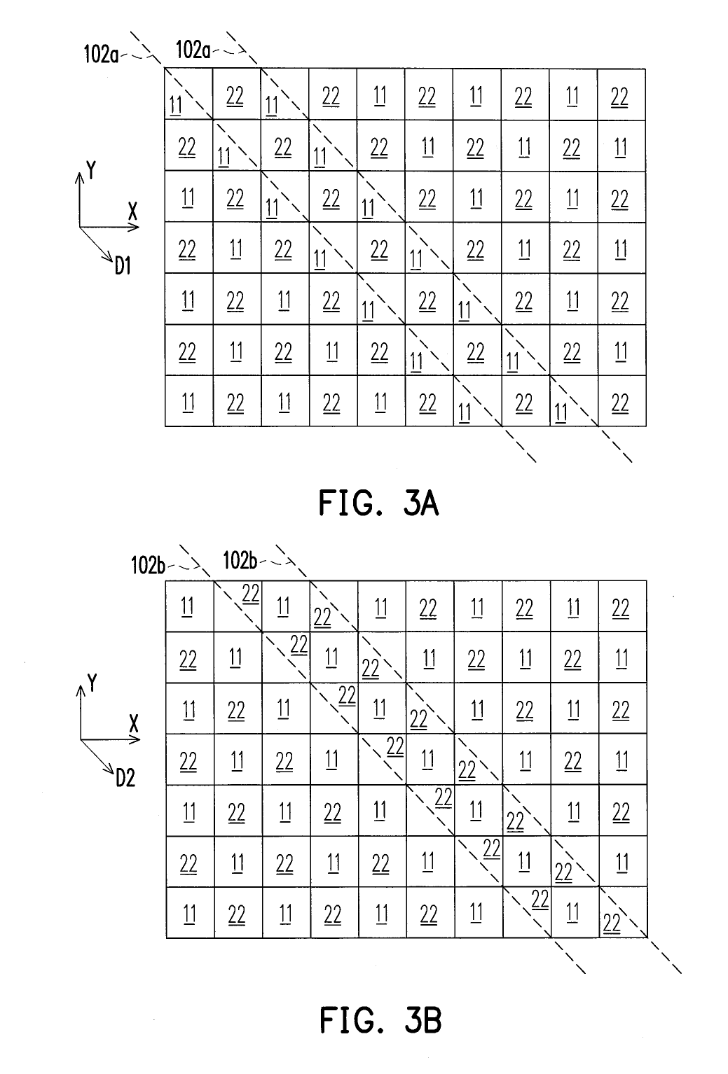

FIG. 3A illustrates a correlation between first driving electrodes and pixels of a display panel. FIG. 3B illustrates a correlation between second driving electrodes and pixels of a display panel. Note that a pair of first driving electrodes is exemplarily shown in FIG. 3A, and a pair of the second driving electrodes is exemplarily shown in FIG. 3B. The number of the first and second driving electrodes is not limited in the invention and can be properly determined based on actual demands. With reference to FIG. 3A and FIG. 3B, in the present embodiment, an extension direction D1 of the first driving electrodes 102a is parallel to an extension direction D2 of the second driving electrodes 102b. The pixels 11 and 22 of the display panel 200 are arranged in matrix along a column direction y and a row direction x. The extension direction D1 of the first driving electrodes 102a and the extension direction D2 of the second driving electrodes 102b interlace with the column direction y and the row direction x. That is to say, the extending directions of the first driving electrodes 102a and the second driving electrodes 102b may tilt respect to the column direction y ,and he first driving electrodes 102a and the second driving electrodes 102b may be alternately arranged along the row direction x. Besides, the first pixels 11 and the second pixels 22 of the display panel 200 may be alternately arranged in the column direction y and the row direction x. Namely, in the present embodiment, the first pixels 11 and the second pixels 22 may be arranged in a chessboard-like manner.

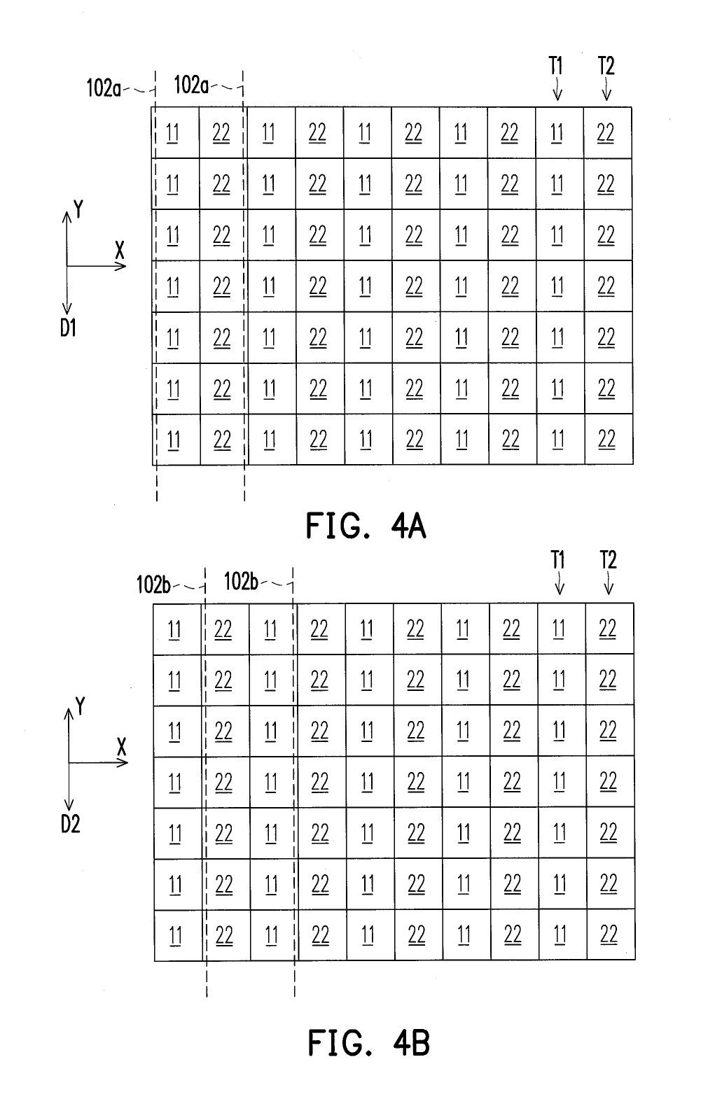

Note that the correlation of the first driving electrodes, the second driving electrodes, and the display panel is not limited to the above, and other correlations will be exemplified hereinafter. FIG. 4A illustrates another correlation between first driving electrodes and pixels of a display panel. FIG. 4B illustrates another correlation between second driving electrodes and pixels of a display panel. Note that a pair of first driving electrodes is exemplarily shown in FIG. 4A, and a pair of the second driving electrodes is exemplarily shown in FIG. 4B. With reference to FIG. 4A and FIG. 4B, in the present embodiment, the extension direction D1 of the first driving electrodes 102a and the extension direction D2 of the second driving electrodes 102b may be parallel to the column direction y. That is to say, the first driving electrodes 102a and the second driving electrodes 102b may extend along the column direction y and may be alternately arranged along the row direction x. Besides, the first pixels 11 of the display panel 200 may be arranged in a plurality of first columns T1 along the column direction y, and the second pixels 22 of the display panel 200 may be arranged in a plurality of second columns T2 along the column direction y. The first columns Ti and the second columns T2 may be alternately arranged along the row direction x.

In light of the foregoing, the auto-stereoscopic display apparatus described in an embodiment of the invention drives two alternately-arranged sets of driving electrodes within different sub-frame periods, such that the liquid crystal lens array may guide a plurality of sub-frames displayed by two sets of pixels to the left and right eyes of a user. The user is thus allowed to watch a stereoscopic image at full resolution on the display apparatus.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An auto-stereoscopic display apparatus comprising:
a liquid crystal lens array comprising:
a first substrate having a plurality of first driving electrodes electrically connected to one another and a plurality of second driving electrodes electrically connected to one another, wherein the first driving electrodes are electrically insulated from the second driving electrodes, and the first and second driving electrodes are alternately arranged;
a second substrate located opposite to the first substrate and having a common electrode; and
a liquid crystal layer located between the first substrate and the common electrode of the second substrate; and
a display panel having a plurality of pixels arranged in array, the pixels being divided into a plurality of first pixels and a plurality of second pixels, wherein when the first driving electrodes are enabled and the second driving electrodes are disabled, the first pixels display a first left-eye sub-frame and the second pixels display a first right-eye sub-frame, and when the second driving electrodes are enabled and the first driving electrodes are disabled, the first pixels display a second right-eye sub-frame and the second pixels display a second left-eye sub-frame.

2. The auto-stereoscopic display apparatus as recited in claim 1, the first pixels displaying the first left-eye sub-frame and the second pixels displaying the first right-eye sub-frame within a first sub-frame period, the first pixels displaying the second right-eye sub-frame and the second pixels displaying the second left-eye sub-frame within a second sub-frame period, wherein the first sub-frame period, the second sub-frame period, and a time interval between the first sub-frame period and the second sub-frame period in total are shorter than or equal to a visual persistence time frame of human eyes.

3. The auto-stereoscopic display apparatus as recited in claim 1, wherein the first driving electrodes and the common electrode together form a first electric field distribution, the second driving electrodes and the common electrode together form a second electric field distribution, and the first electric field distribution and the second electric field distribution do not overlap.

4. The auto-stereoscopic display apparatus as recited in claim 3, wherein the first substrate further comprises an insulating layer located between the first driving electrodes and the second driving electrodes.

5. The auto-stereoscopic display apparatus as recited in claim 4, wherein the second driving electrodes being located on a same plane where the insulating layer is located, the second driving electrodes are also located between the insulating layer and the second substrate, the first substrate further having a first base, the first driving electrodes and the second driving electrodes are located on the first base, the first driving electrodes are located on a same plane of the first base, and the first driving electrodes are located between the insulating layer and the first base.

6. The auto-stereoscopic display apparatus as recited in claim 3, wherein the first driving electrodes and the second driving electrodes are located on a same plane.

7. The auto-stereoscopic display apparatus as recited in claim 3, wherein an extension direction of the first driving electrodes is parallel to an extension direction of the second driving electrodes, the pixels are arranged in matrix along a column direction and a row direction, and the extension direction of the first driving electrodes and the extension direction of the second driving electrodes interlace with the column direction and the row direction.

8. The auto-stereoscopic display apparatus as recited in claim 7, wherein the first pixels and the second pixels are alternately arranged in the column direction and the row direction.

9. The auto-stereoscopic display apparatus as recited in claim 3, wherein an extension direction of the first driving electrodes is parallel to an extension direction of the second driving electrodes, the pixels are arranged in matrix along a column direction and a row direction, and the extension direction of the first driving electrodes and the extension direction of the second driving electrodes are substantially parallel to the column direction.

10. The auto-stereoscopic display apparatus as recited in claim 9, wherein the first pixels are arranged in a plurality of first columns along the column direction, the second pixels are arranged in a plurality of second columns along the column direction, and the first columns and the second columns are alternately arranged along the row direction.
